(19) United States
(12) Patent Application Publication
(10) Pub. No.: US 2012/0062689 A1
(43) Pub. Date: Mar. 15, 2012

(54) PERSONALIZED VIRTUAL VIDEO MEETING ROOMS

(75) Inventors: Krishna Sai, Cedar Park, TX (US); Alain Nimri, Austin, TX (US); Edward Brakus, Austin, TX (US); Jonathan Gallmeier, Austin, TX (US)

(73) Assignee: POLYCOM, INC., Pleasanton, CA (US)

(21) Appl. No.: 12/880,970

(22) Filed: Sep. 13, 2010

(51) Int. Cl. H04N 7/15

(52) U.S. Cl. 348/14.09; 348/E07.084

(57) ABSTRACT

A videoconferencing system allows host users to personalize virtual meeting rooms (VMR). A multipoint control unit (MCU) generates VMRs using associated VMR configuration parameters, which include personal VMR parameters specified by the host user, and admin VMR parameters specified by an administrator of the videoconferencing system. The host user can connect to a server at the MCU to request a list of personal VMR parameters, for which the host user can specify values. The server can receive and store the specified values for the personal parameters. The MCU can combine the values of personal VMR parameters with values of admin VMR parameters in generating VMR configuration.

### FIELD OF THE INVENTION

The present invention relates generally to videoconferencing systems, and more particularly personalized virtual meeting rooms.

### BACKGROUND

Videoconferencing between two or more users typically involves a multipoint control unit (MCU). An MCU can receive audio and video streams from each user's videoconferencing terminal, mixes them to produce mixed audio and video streams, and transmits the mixed audio and video streams back to the user terminals. In one instance, a host, say user A, can invite other users to join a videoconferencing session by providing them with a number or identifier, which can be presented to the MCU during call initiation. When the user terminal presents the number of identifier to the MCU, the MCU can identify that user terminal as joining a videoconferencing session hosted by user A. The MCU can then present the user terminal with a communication environment associated with user A.

The communication environment is typically called a virtual meeting room (VMR), and the associated number or identifier is typically called a VMR number. When users dials in to join a videoconferencing session, the user can be presented with gathering phase information that may include a voice greeting followed by a visual presentation containing information such as the name of the meeting, name of the host, names of other invited users, names of the users that have already joined, etc. Gathering phase information can also be accompanied by some music while the user waits for the meeting to get underway. Once the videoconferencing begins, the MCU can present video of other participants to the user with a particular layout. Typically, this layout will be based on the number of participants, the number of display screens at the user, etc.

Traditionally, VMRs are configured by an administrator of the MCU. The administrator can configure certain parameters that are common to all VMRs supported by the MCU. These parameters can include, for example, dial plan for the VMRs, gathering phase information, maximum number of users, etc. For example, FIG. 1 shows a list of VMR parameters 101 configured by an administrator of an MCU. Parameters within Common Configuration 102 apply all the VMRs. For example, the same “Gathering phase music” will be played for users of both VMR-A and VMR-B. Additionally, “No. of VMRs” determines the maximum number of VMRs that the MCU can support. Parameters listed under “Default VMR configuration” can be applied to VMRs for which these parameters have not been specified. Unique parameters for various VMRs, VMR-A 103 and VMR-B 104 can also be defined.

However, these traditional MCUs do not allow the host user to personalize the VMRs assigned to them. As a result, the host user is unable to provide useful information to the users after they have entered the VMR.

### SUMMARY

A multipoint control unit (MCU) can allow host users of a videoconferencing system to specify personal parameters for virtual meeting rooms (VMRs). The MCU can assign a virtual meeting room for each user and assign a VMR identifier to each VMR. A user can distribute the VMR identifier to guest users who wish to join a videoconferencing session. A guest user can present the VMR identifier to the MCU during establishment of the videoconference. The MCU can present the guest user a VMR associated with the received VMR identifier.

The MCU can include a database for storing VMR parameters that include both personal VMR parameters specified by the users and admin VMR parameters specified by the administrator. Host users and administrator can access and modify VMR parameters via a server. The server can be a web server and the host user or administrator can modify VMR parameters by requesting a webpage in a web browser. VMR parameter values can be selected or entered on the webpage and sent back to the server. The server can then subsequently update the database.

Personal VMR parameters can include the title, theme, background image, background video, gathering phase music, RSS newsfeeds, video layout, optional meeting URL, etc. Admin VMR parameters can include parameters that are related to specific VMRs or can include common parameters that apply to all VMRs. For example, common parameters can include total number of VMRs, gathering phase music, default VMR parameters, etc.

The MCU can include a control module that can generate a VMR based on the both the personal VMR parameters and the admin VMR parameters. The control module can also use an audio and video module to generate audio and video streams that include the VMR configured based on personal and admin VMR parameters.

### BRIEF DESCRIPTION OF THE DRAWINGS

Exemplary embodiments of the present invention will be more readily understood from reading the following description and by reference to the accompanying drawings, in which:

FIG. 1 illustrates a list of administrator virtual meeting room parameters.

FIG. 2 depicts an exemplary system for carrying out a videoconferencing session.

FIG. 3 shows an exemplary functional block diagram of an multipoint control unit (MCU).

FIG. 4 focuses on an exemplary block diagram of the MCU for combining personal and admin VMR parameters for virtual meeting rooms.

FIG. 5 illustrates an exemplary list of personal VMR parameters.

FIG. 6 shows an exemplary webpage for selecting values for a list of personal VMR parameters.

FIG. 7 shows an exemplary image of a VMR.

### DETAILED DESCRIPTION

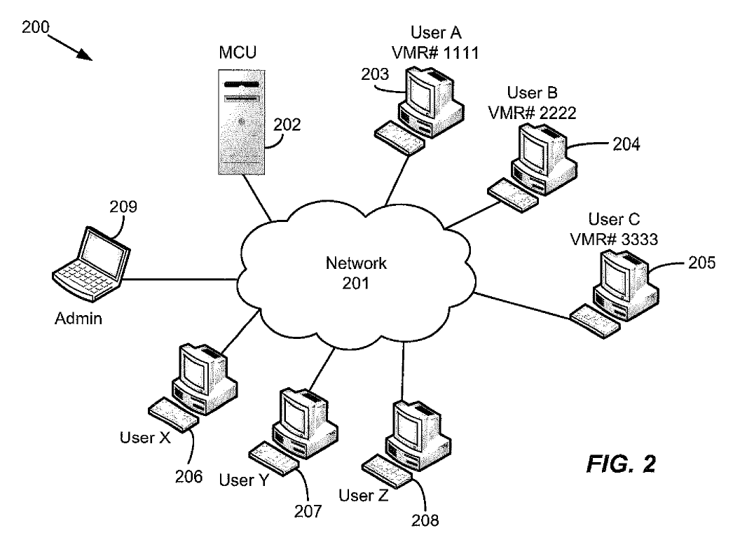

FIG. 2 depicts an exemplary system in which the MCU 202 can allow users to personalize VMRs. MCU 202 can establish videoconference sessions among users communicating over network 201. Network 201 can include one or more networks, such as Internet, Ethernet, telephone network, wide area network, satellite network, etc. Users A 203, B 204, C 205, X 206, Y 207, and Z 208 can be videoconferencing terminals or endpoints, each one or which can include cameras, microphones, speakers, display devices, communication terminal, etc. Audio, video, and other data from microphones and camera can be transmitted by the endpoint to the MCU 202. Likewise, mixed audio, video, and data can be received from the MCU 202 by the endpoints and sent to their respective speakers and display devices. An administrator terminal 209 can remotely communicate with the MCU 202 for carrying out management functions.

Users A 203, B 204, and C 205 (host users) can be assigned VMRs at the MCU 202. These VMRs can have associated identification numbers. For example, VMR for user A 203, VMR-A, can have a VMR number 1111 associated with it. Similarly, VMR-B and VMR-C can have VMR numbers 2222 and 3333, respectively, associated with them. Users having VMRs assigned at the MCU 202 can distribute the associated VMR numbers to other users they wish to invite to join a videoconferencing session. For example, user A 203 wanting to invite user X 206, user Y 207, and user Z 208 (guest users) can ask them to enter the VMR number 1111 when establishing connection with MCU 202. On receiving VMR number 1111 from the guest users, the MCU 202 can setup a videoconferencing session between guest users X 206, Y 207, Z 208, and host user A 203 within an environment described by configuration parameters of VMR-A. Similarly, MCU 202 can setup a videoconferencing session in VMR-B (host user B 204) and VMR-C (host user C 205) upon receiving VMR numbers 2222 and 3333, respectively.

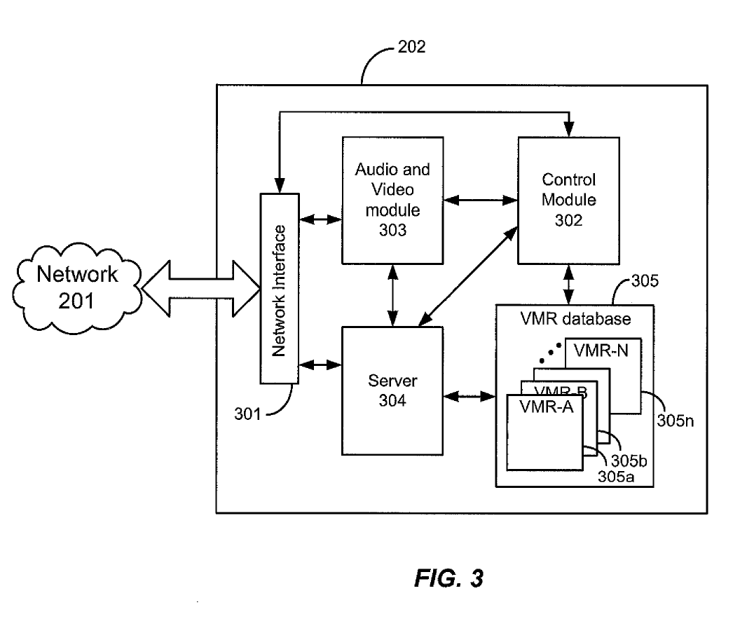

FIG. 3 depicts an exemplary block diagram of MCU 202. MCU 202 can communicate with endpoints 203-208 via network 201. Although the example of FIG. 3 shows the MCU 202 as a separate entity, the MCU 202 can also be located at and be part of one of the endpoints 203-208. MCU 202 can connect to the network 201 via a network interface 301. The network interface 301 can receive multimedia communication from endpoints 203-208 via network 201 and can process the multimedia communication according to communication standards such as H.323, H.320, Session Initiation Protocol (SIP), etc. Audio and video module 303 can receive audio and video streams from endpoints 203-208. These received audio and video streams can be mixed by the audio and video module 303 to generate output streams that can be sent to one or more of the endpoints 203-208. Audio and video module 303 can also include a dual tone multi frequency (DTMF) module for receiving control signals, such as VMR numbers dialed by the uses at the endpoints. Data received from these control signals can be communicated to the control module 302. Control module 302 can control all the modules and operations of the MCU 202, and can include logic modules for processing control signals sent/received to/form the endpoints 203-208 and the administrator 209. Control module 302 can employ these control signals to establish one or more videoconferencing sessions among the endpoints 203-208.

MCU 202 can also include Server 304 and a VMR database 305. Server 304 can allow users at host users A-C 203-205 to communicate with the MCU 202 for modifying the parameters of their respective VMRs. In one instance, server 304 can be a HTTP (hypertext transfer protocol) server allowing users at endpoints 203-208 to use a HTTP client (e.g., web browser) to access their VMR parameters. VMR parameters can be stored in a VMR database 305, which can communicate with server 304. Users can generate, access, modify, and store VMR parameters in the VMR database 305 via server 304. For example, user A 203 can access and modify associated parameter list VMR-A 305a, user B 204 can access and modify associated parameter list VMR-B 305b, and so on. Server 304 can provide host users with a user interface, in HTML, Flash, Java applets, etc., so that users can select individual parameters and specify personalized values for those parameters. Server 304 and database 305 can include security and confidentiality features to defend against unauthorized access to the VMR database 305. For example, server 304 can have users enter a username and password for authentication. Additionally, users can be restricted access to the parameters associated with their own VMRs only.

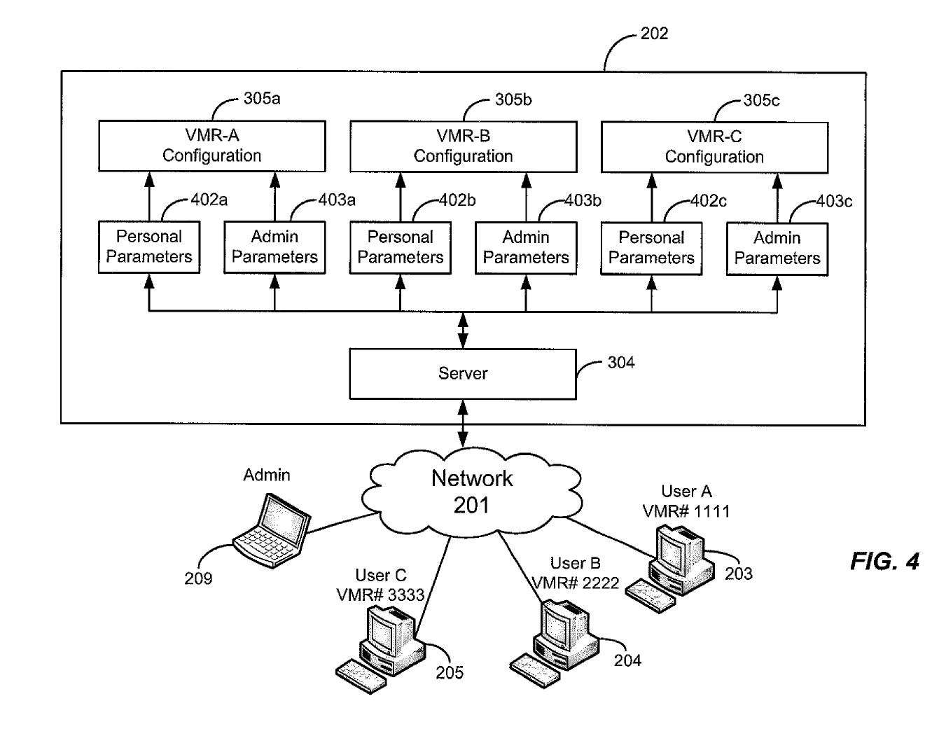

VMR parameters 305a-305n can include administrator VMR parameters in addition to personal VMR parameters (defined by the host user). FIG. 4 shows an example where VMR configuration is composed of personal VMR parameters and admin VMR parameters. Users A-C 203-205 and admin 209 can be logged in by server 304 to allow access to VMR parameters. Users can be allowed to access and modify only personal parameters associated with their VMR. For example, user A 203 can be allowed access to only personal parameters 402a associated with VMR-A configuration 305a. Similarly, user B 204 and user C 205 can only access personal parameters 402b and 402c, respectively. The administrator can be allowed to access admin parameters of all VMRs. For example, Admin 209 can be allowed access to Admin parameters 403a, 403b, and 403c. Both the personal parameters (e.g., 402a-c) and admin parameters (403a-c) can be combined to generate the VMR configuration.

Control module 302 can access the configuration parameters for a VMR and generate audio-visual content accordingly. For example, if guest user X 206 were to present a VMR number 2222, then the control module 302 can access VMR configuration parameters for VMR-B 305b, and process audio and video streams to be sent to user X 206 based on these parameters. Control module 302 can access gathering stage parameters from VMR and generate audio and video streams accordingly. For example, if the gathering phase parameters specify that the user receive an audio greeting, then the control module 302 can control the audio and video module 303 to generate the audio greeting stream and then transmit the stream to the user. As another example, if the configuration parameters specify that the VMR have a video layout having 2×2 grid of video streams, then the control module 302 can control the audio and video module 303 to generate a composite video stream that includes video images from four sources laid out in a 2×2 grid, and transmit the composite video stream to the users associated with that VMR.

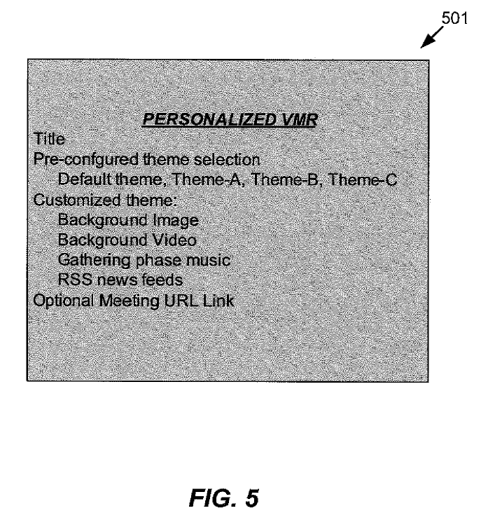

FIG. 5 lists an exemplary list 501 of personalized parameters associated with a VMR. List 501 is not exhaustive, and may include additional personal VMR parameters as required. A user can select the Title of the VMR, which title can be presented to the users when they join the videoconferencing session. The title can be presented visually by displaying it on the endpoint's display device, presented acoustically by sending an audio stream to the endpoint's speakers, or both. Control module 302 can utilize the audio and video module 303 to generate an audio stream using a text to audio converter.

Host users can also specify the gathering phase parameters for the videoconferencing session. Recall that a guest user (e.g., users X 206, Y 207, and Z 208) joining a videoconference is put in a gathering phase from the time he/she enters the VMR number to the time when audio-visual communication with other users begins. During this time, traditional MCUs presented guest users of all VMRs with the same content. But, with personalized parameters, the host users can personalize one or more aspects of the gathering phase. For example, the host user can specify the background image of the VMR or present an introduction video or slide show to the guest users. The music to be played can also be specified. Typically, the host user can select one or more previously stored audio files in the database 305, and stream the audio content of the audio file to the guest user. Additionally, guest users can be presented with RSS (Really Simple Syndication) news feeds. The host user can of course personalize these parameters keeping in mind the topic of the videoconferencing session.

Personalized parameters 501 can also include conference parameters that specify the default layout of the videoconferencing session as seen by the users. For example, for a videoconferencing between four users, the layout parameters of the VMR can be specified to present a 2×2 grid of image windows, in which three of the image windows can display video stream from three other users. The fourth image window can receive a video stream of the ongoing slide presentation, relevant document, or other data. Personal VMR parameter list can specify various combinations of video layouts based on the number of users. Therefore, when the number of users within the videoconferencing changes, layout of the VMR can change accordingly. Personalized parameters can also specify whether the videoconferencing session in the VMR is to be recorded. The parameters may specify whether only audio, only video, or both are to be recorded. Location of storage of recorded VMR sessions can also be specified.

A user can also select from a number of “themes,” which represent a set of predefined personal VMR parameters. For example, a host user can predefine a theme for frequently held videoconferencing sessions. Such themes, can have predefined values for personal VMR parameters such as, gathering phase music, background image, background video, RSS news feed, layout, etc. By selecting a theme, the user does not have to select values for every individual personal VMR parameter.

Additional personal VMR parameters can specify websites and URLs that the VMR can display. For example, the host user can configure the VMR to display the guest user's social networking webpage such as Facebook, Twitter, etc. This content can be configured to be displayed during the gathering phase as well as overlaid on the video during the videoconferencing session. VMR parameters can also be specified to provide the guest users with a browser window for the guest users to browse the Internet whilst waiting for the gathering phase to end.

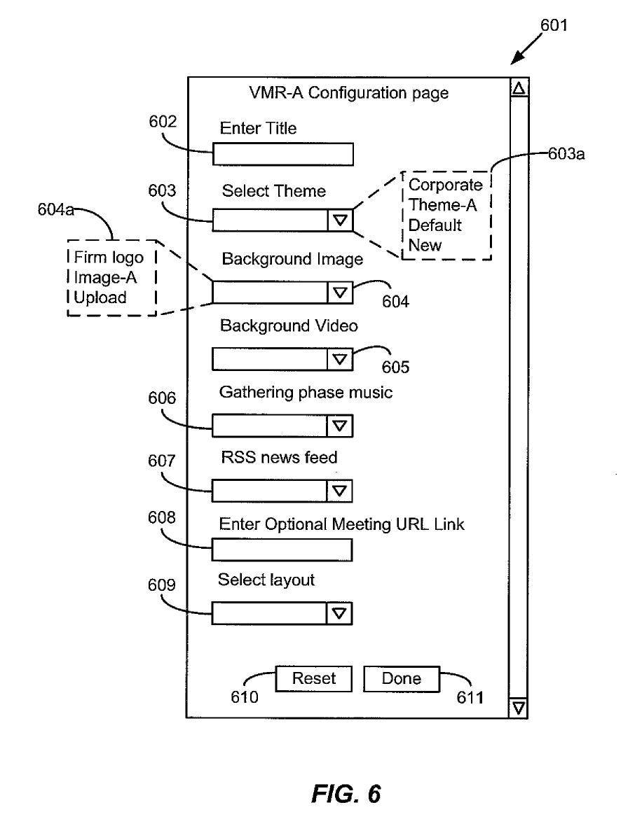

FIG. 6 shows and exemplary webpage 601 provided by server 304 to host user A 203 for configuring VMR-A. Webpage 601 can be generated by server 304 using well-known tools (such as, HTML, XHTML, PHP, Perl, Javascript, etc.) and may be sent to host user A's 203 computer after host user A has been authenticated. Webpage 601 can include web-forms to allow entering and selecting values for various VMR parameters. User A 203 can enter the title of the VMR in field 602. Themes with predetermined configuration parameters can also be selected using pull-down list 603. As an example, the list 603a can include Corporate theme, Theme-A, a Default theme, or select New for storing a new theme. If the user prefers to configure individual personal VMR parameters, then the user can select values for Background Image from pull-down list 604. List 604a can also include an option for uploading new images. Likewise, pull-down lists can be displayed for other personal VMR parameters such as Gathering phase music 606, RSS news feed 607, Layout 609, etc. User can also enter the optional meeting URL in field 608. User may select the Reset button 610 to reset the values of all the parameters on page 601, or can select the Done button 611 to send the selected values of personal VMR parameters to the server 304. Server 304, in turn, can update the VMR-A parameter 305a in database 305.

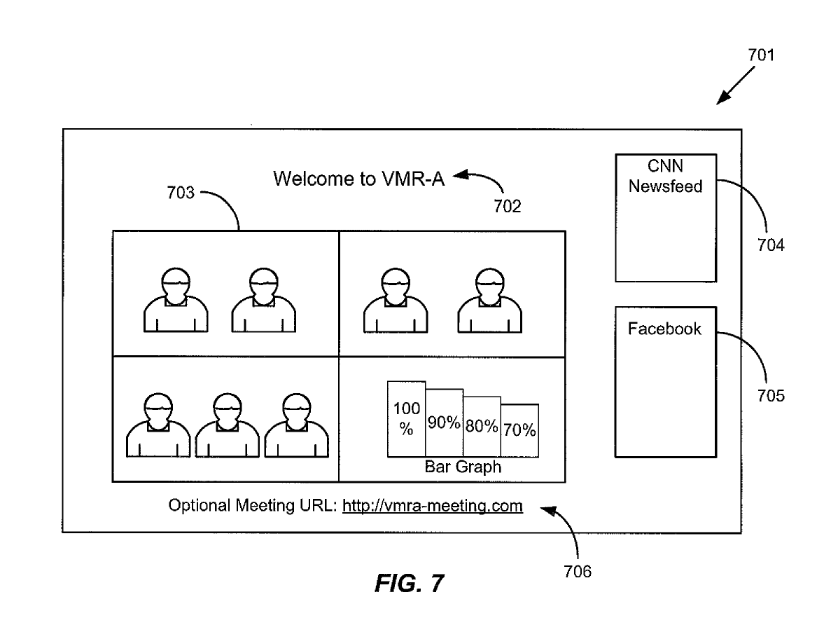

FIG. 7 shows an exemplary virtual meeting room configured by host user A 203, as seen by users participating in the videoconferencing session. The VMR-A 701 can display the title entered by user A 203 in field 602 (FIG. 6), e.g., “Welcome to VMR-A.” VMR-A 701 can also display a RSS newsfeed 704 (e.g., CNN newsfeed) selected by user A 203 in pull-down list 607. Additionally, user A's 203 social networking website 705, e.g., Facebook, and an optional meeting URL 706 can also be displayed according to the selections made by user A 203 on page 601. Layout 703 of video streams from various users and presentation can also be displayed in accordance to the selection made in pull-down list 609 on page 601. A person skilled in the art will appreciate that the VMR-A 701 is not limited either in form or substance as displayed in FIG. 7.

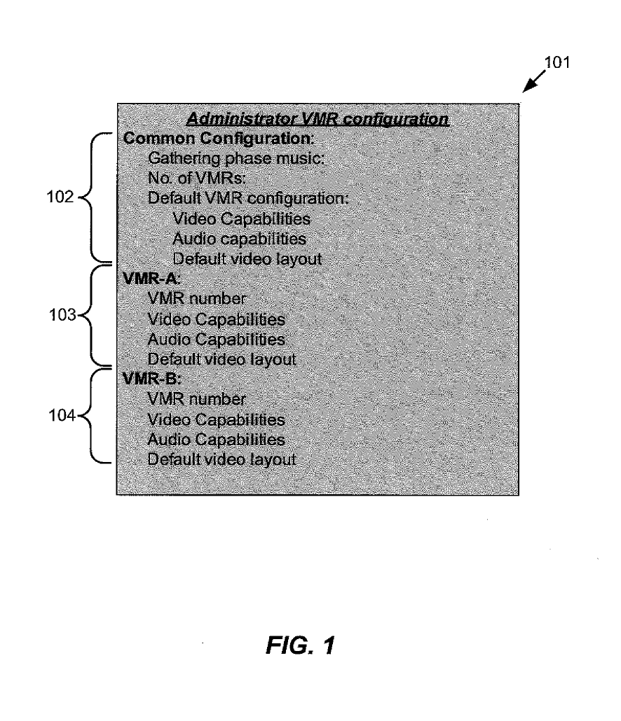

Note that control module 302 can use combined personal and admin VMR parameters to generate a VMR configuration. Admin parameters can be similar to the ones shown in FIG. 1, 101. If a host user, say user A 203, fails to specify values for any personalized parameters 402a, or specifies invalid values, control module 302 may use values of default parameters 103 specified by admin parameters 101 instead. Administrator 209 may also set some admin parameters that can override personal VMR parameters. Additionally, if some personal VMR parameters are incompatible with admin parameters for the same VMR, the control module 302 may give preference to either the admin parameters or the personal VMR parameter.

It is also envisioned that the administrator 209 can be an endpoint similar to users A-C 203-205 and X-Z 206-208, and can participate in a videoconferencing session in the role of a guest user or a host user. Server 304 can present the admin 209 with a webpage similar to webpage 601 to select values for personal VMR parameters when the admin is acting as a host user. Furthermore, server 304 can present the admin 209 with a webpage 601 that lists admin VMR parameters instead of personal VMR parameters.

The above description is illustrative and not restrictive. Many variations of the invention will become apparent to those skilled in the art upon review of this disclosure. The scope of the invention should therefore be determined not with reference to the above description, but instead with reference to the appended claims along with their full scope of equivalents.

What is claimed is:

1. A videoconferencing multipoint control unit (MCU) configured to communicate with a host user and an administrator, comprising:
a network interface configured to communicate with the host user and the administrator;
a server communicatively coupled to the network interface and configured to receive values for personal virtual meeting room (VMR) parameters from the host user and values for admin VMR parameters from the administrator; and
a control module communicatively coupled to the network interface and the server, the control module configured to generate a virtual meeting room based on the personal VMR parameters and the admin VMR parameters.

2. The MCU of claim 1, wherein the server is configured to generate a webpage configured to allow entering or selecting values for the personal VMR parameters, and sending the webpage to the host user.

3. The MCU of claim 2, wherein the server is configured to authenticate the host user before sending the webpage to the host user.

4. The MCU of claim 3, wherein the server receives a identification number associated with the VMR and the host user.

5. The MCU of claim 1, wherein the admin VMR parameters include VMR parameters common to all other VMRs generated by the control module.

6. The MCU of claim 1, further comprising a database communicatively coupled to the server and the control module, wherein the personal VMR parameters and the admin VMR parameters are stored in the database.

7. The MCU of claim 1, wherein the control module is configured to generate a video stream of the virtual meeting room.

8. The MCU of claim 7, wherein the control module is configured to send the video stream of the virtual meeting room to one or more guest users via the network interface.

9. The MCU of claim 1, wherein one parameter of personal VMR parameters is same as one parameter of admin VMR parameters, and the control module uses a value for the same parameter from the one specified in personal VMR parameters.

10. The MCU of claim 1, wherein one parameter of personal VMR parameters is same as one parameter of admin VMR parameters, and the control module uses a value for the same parameter from the one specified in admin VMR parameters.

11. A method for establishing a videoconferencing session between a host user and one or more guest users at a multipoint control unit (MCU), the MCU configured to communicate with the host user, the one or more guest users and an administrator, comprising:
receiving values of a first set of virtual meeting room (VMR) parameters from the host user;
receiving values for a second set of VMR parameters from the administrator;
combining the values of the first set of VMR parameters and the second set of VMR parameters to form a VMR configuration; and
generating a VMR based on the VMR configuration.

12. The method of claim 11, further comprising generating a webpage configured to allow entering or selecting values for the first set of VMR parameters, and sending the webpage to the host user.

13. The method of claim 12, further comprising authenticating the host user before sending the webpage to the host user.

14. The method of claim 13, wherein authenticating the host user includes receiving an identification number associated with the VMR and the host user.

15. The method of claim 11, wherein the second set of VMR parameters comprise configuration parameters common to all other VMRs generated at the MCU.

16. The method of claim 11, further comprising storing the VMR configuration in a database.

17. The method of claim 11, wherein generating the VMR comprises generating a VMR video stream.

18. The method of claim 17, further comprising sending the VMR video stream to the one or more guest user.

19. The method of claim 11, wherein the first set of VMR parameters and the second set of VMR parameters have one or more same VMR parameters, and wherein combining comprises selecting values for the one or more same VMR parameters from the values for the second set of VMR parameters.

20. The method of claim 11, wherein the first set of VMR parameters and the second set of VMR parameters have one or more same VMR parameters, and wherein combining comprises selecting values for the one or more same VMR parameters from the values for the first set of VMR parameters.

21. A method for conducting a videoconferencing session at a multipoint control unit (MCU) configured to communicate with a plurality of endpoints, a host endpoint and an administrator endpoint, the method comprising:
receiving a virtual meeting room (VMR) identification from at least one of the plurality of endpoints;
accessing values for a set of VMR parameters associated with the VMR identification;
establishing the videoconferencing session with the at least one of the plurality of endpoints based on the values of the set of VMR parameters,
wherein the set of VMR parameters include one or more personal parameters received from the host endpoint and one or more admin parameters received from the administrator endpoint.

22. The method of claim 21, wherein establishing the videoconferencing comprises generating a VMR based on the set of VMR parameters.

23. The method of claim 22, wherein establishing the videoconferencing further comprises generating a VMR video stream of the generated VMR.

24. The method of claim 23, wherein establishing the videoconferencing further comprises sending the VMR video stream to the at least one of the plurality of endpoints.

25. The method of claim 22, wherein at least one of the one or more personal parameters relates to gathering phase music to be played during a gathering phase of the videoconferencing session.

26. The method of claim 22, wherein at least one of the one or more personal parameters relates to displaying newsfeeds in the VMR.

27. The method of claim 22, wherein at least one of the one or more personal parameters relates to a VMR theme, wherein the VMR theme includes preset values for one or more other personal parameters.
